(19) United States
(12) Patent Application Publication
(10) Pub. No.: US 2026/0186837 A1
(43) Pub. Date: Jul. 2, 2026

(54) UNIFIED SOFTWARE TASK-PROCESSING FRAMEWORK FOR SEAMLESS TASK MANAGEMENT ACROSS DIVERSE SOFTWARE APPLICATIONS

(71) Applicant: Microsoft Technology Licensing, LLC, Redmond, WA (US)

(72) Inventor: Hariharan ANANTHARAMAN, Redmond, WA (US)

(73) Assignee: Microsoft Technology Licensing, LLC, Redmond, WA (US)

(21) Appl. No.: 19/001,995

(22) Filed: Dec. 26, 2024

(51) Int. Cl. G06F 9/50

(52) U.S. Cl. CPC G06F 9/5027

(57) ABSTRACT

A software task-processing framework system and method are provided for managing processing of task functions in a first software application and a second software application, including generating order packets, including source and destination addresses and payloads, including the task functions and corresponding rollback functions programmed to automatically rollback processing of the task functions upon detecting a failure in processing the task functions by the first and second software applications.

### BACKGROUND

In modern computing environments, managing task-processing in computer software applications reliably across different execution contexts in a management framework for managing the task processing is a significant technical challenge. Existing systems often lack a unified framework to handle such task processing (which can also be referred to as transaction processing) seamlessly across these execution contexts in the management framework, leading to increased complexity, potential data inconsistencies, and difficulties in ensuring atomicity, consistency, isolation, and durability (which can be referred to as ACID properties). This is the case whether the task processing is within a software application for a single process on one computer, across multiple processes within multiple software applications on the same computer or distributed across multiple software applications on multiple computers. Hence, a unified software task-processing framework for seamless task management across diverse execution contexts of the framework for managing the task processing in multiple software applications is highly desirable.

### SUMMARY

An example data processing system according to the disclosure includes a software task-processing framework system for managing processing of task functions in a first software application and a second software application coupled to the software task-processing framework system, the system including a processor and a memory storing executable instructions that, when executed, cause the processor alone or in combination with other processors to perform operations of distributing a request for processing first and second task functions in the first and second software applications, respectively, to the software task-processing framework system, generating a first order packet, via the software task-processing framework system, including a source address to identify the software task-processing framework system as a source, a destination address to identify the first software application as a first destination, and a first payload, the first payload including the first task function and a first rollback function, wherein the first rollback function is programmed to automatically rollback processing of the first task function upon detecting a failure in processing the first task function by the first software application, generating a second order packet, via the software task-processing framework system, including a source address to identify the software task-processing framework system as the source, a destination address to identify the second software application as a second destination, and a second payload, the second payload including the second task function and a second rollback function, wherein the second rollback function is programmed to automatically rollback processing of the second task function upon detecting a failure in processing the second task function by the second software application, dispatching for processing the first order packet to a first software task processor in the first software application and the second order packet to a second software task processor in the second software application, determining, via the software task-processing framework system, whether the first and second task functions have each been executed successfully in the first and second software applications, respectively, by the first and second software task processors, and upon determining, via the software task-processing framework system, that either of the first and second task processors did not successfully perform the respective first or second task functions, automatically providing a rollback command to both the first and second task processors, via the software task-processing framework system, to direct the first and second task processors to execute the first and second rollback functions, respectively, to roll back the processing of the first and second task functions.

An example method for managing processing of task functions in a first software application and a second software application, via coupled a software task-processing framework system coupled to the first and second software applications, the method including distributing a request for processing first and second task functions in the first and second software applications, respectively, to the software task-processing framework system, generating a first order packet, via the software task-processing framework system, including a source address to identify the software task-processing framework system as a source, a destination address to identify the first software application as a first destination, and a first payload, the first payload including the first task function and a first rollback function, wherein the first rollback function is programmed to automatically rollback processing of the first task function upon detecting a failure in processing the first task function by the first software application, generating a second order packet, via the software task-processing framework system, including a source address to identify the software task-processing framework system as the source, a destination address to identify the second software application as a second destination, and a second payload, the second payload including the second task function and a second rollback function, wherein the second rollback function is programmed to automatically rollback processing of the second task function upon detecting a failure in processing the second task function by the second software application, dispatching for processing the first order packet to a first software task processor in the first software application and the second order packet to a second software task processor in the second software application, determining, via the software task-processing framework system, whether the first and second task functions have each been executed successfully in the first and second software applications, respectively, by the first and second software task processors, and upon determining, via the software task-processing framework system, that either of the first and second task processors did not successfully perform the respective first or second task functions, automatically providing a rollback command to both the first and second task processors, via the software task-processing framework system, to direct the first and second task processors to execute the first and second rollback functions, respectively, to roll back the processing of the first and second task functions.

An example computer program product for managing processing of task functions in a first software application and a second software application, via coupled a software task-processing framework system coupled to the first and second software applications, according to the disclosure includes instructions stored thereon that, when executed by a processing system, perform a method including distributing a request for processing first and second task functions in the first and second software applications, respectively, to the software task-processing framework system, generating a first order packet, via the software task-processing framework system, including a source address to identify the software task-processing framework system as a source, a destination address to identify the first software application as a first destination, and a first payload, the first payload including the first task function and a first rollback function, wherein the first rollback function is programmed to automatically rollback processing of the first task function upon detecting a failure in processing the first task function by the first software application, generating a second order packet, via the software task-processing framework system, including a source address to identify the software task-processing framework system as the source, a destination address to identify the second software application as a second destination, and a second payload, the second payload including the second task function and a second rollback function, wherein the second rollback function is programmed to automatically rollback processing of the second task function upon detecting a failure in processing the second task function by the second software application, dispatching for processing the first order packet to a first software task processor in the first software application and the second order packet to a second software task processor in the second software application, determining, via the software task-processing framework system, whether the first and second task functions have each been executed successfully in the first and second software applications, respectively, by the first and second software task processors, and upon determining, via the software task-processing framework system, that either of the first and second task processors did not successfully perform the respective first or second task functions, automatically providing a rollback command to both the first and second task processors, via the software task-processing framework system, to direct the first and second task processors to execute the first and second rollback functions, respectively, to roll back the processing of the first and second task functions

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIGS. 1A and 1B are diagrams of examples computing environment in which the techniques described herein can be implemented.

FIG. 2A is a diagram showing an example implementation of the task-processing framework shown in FIG. 1.

FIG. 2B is a diagram showing an example implementation of a first order packet shown in FIG. 2A.

FIG. 2C(1)-(3) show an example implementation of code for a payload in the first order packet shown in FIG. 2A.

FIG. 3 is a diagram showing an example implementation of a first action unit shown in FIG. 2A.

FIG. 4 is a diagram showing an example implementation of a second action unit shown in FIG. 2A.

FIG. 5 is a diagram showing an example implementation of a third action unit shown in FIG. 2A.

FIG. 6 is a flow chart of an example process for managing processing of task functions in a first software application and a second software application coupled to the software task-processing framework system according to the techniques disclosed herein.

FIG. 7 is a block diagram showing an example software architecture, various portions of which may be used in conjunction with various hardware architectures herein described, which may implement any of the described features.

FIG. 8 is a block diagram showing components of an example machine configured to read instructions from a machine-readable medium and perform any of the features described herein.

### DETAILED DESCRIPTION

This disclosure is directed to the technical field of providing a framework, which is a software application, configured for managing task processing in other software applications that the framework. This includes frameworks for managing the performance of task functions in software applications, including in multiple software applications, and canceling the task-processing functions in the software applications upon detection of failure of the task function processing in one or more of the software applications. Such task functions can include performing security updates for software applications on the same computer or different computers (or servers) using diverse execution contexts in a unified software update framework. It is noted that the term “execution context” as used herein refers to an environment or “container” in the management framework (e.g., program), that stores variables and provides an environment for managing code to run and to issue orders to the other software applications being managed. The term “execution context” is commonly used in this regard for programs created using JavaScript. In the examples given herein, each software program is controlled by its own execution context in the task-processing framework. However, if desired, one execution context could send orders to multiple software applications being managed by the task-processing framework.

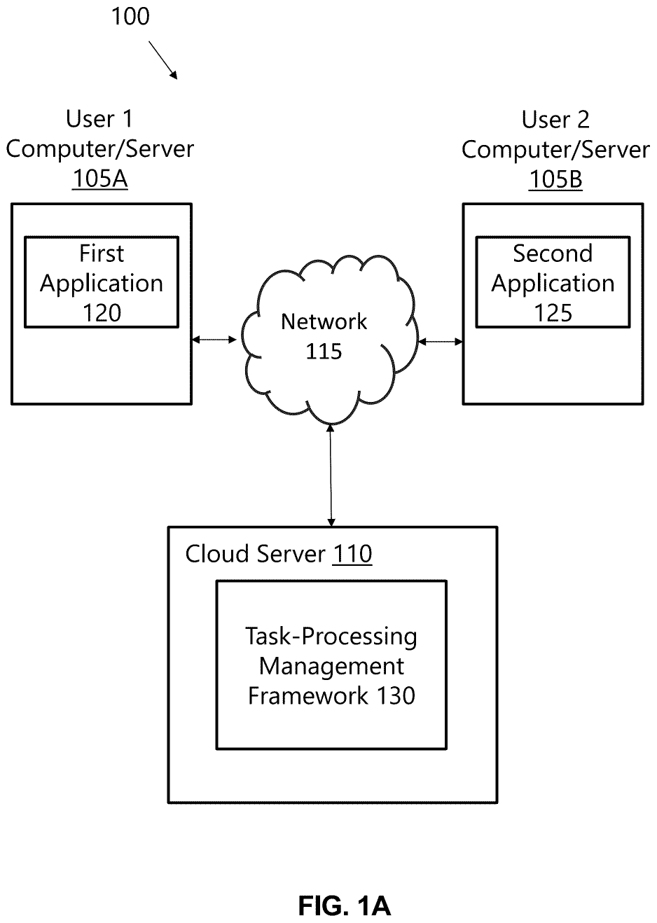

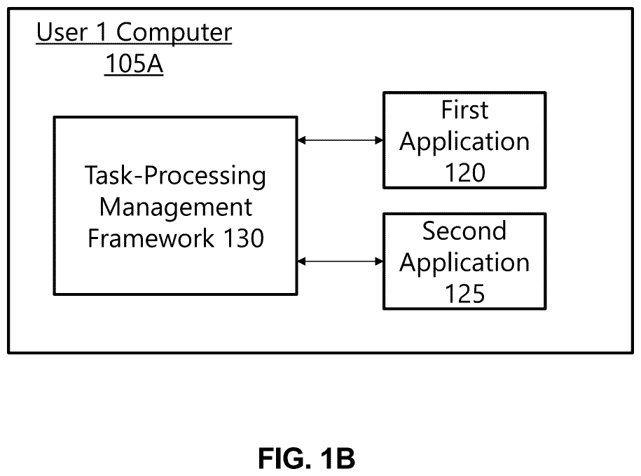

An example of such a unified management framework having such diverse execution contexts (e.g., one execution context coupled to each of different software applications being managed) according to the present disclosure can be for providing security updates to common or related software applications on two or more different computing devices (e.g., one of the applications of a first user's computer and one of the applications of a second user's computer). In another implementation, a unified management framework having diverse execution contexts can be provided on a user's machine and used to provide security updates to different applications on the same computing device. For purposes of simplification, the following discussion will primarily be made in terms of managing task processing (such as updating software) on two different user devices connected to one another via the cloud, as shown in FIG. 1 (although, obviously, many more user devices could be updated, if desired). In this scenario, the task-processing management framework can be a cloud server, but, alternatively, the framework would be provided in one of the user devices.

Similarly, as another example, in a data center where multiple servers are used in an interconnected fashion to carry out operations, it is important that any security updates be applied to all of the servers. Another possible implementation of the present disclosure is two or more applications on the same computer which are related to one another, or dependent upon one another in terms of coordinating to perform given operations such as security updates. In any of these situations, either all of the applications need to be successfully updated, or all of the updates need to be rolled back so that the problems can be resolved before a group update is attempted again.

The technical solution of the present disclosure, as will be discussed in detail herein, is to encapsulate both software task-processing functions and rollback functions of the software task-processing functions (which rollback functions are opposite to the software task-processing functions) as payloads in order packets provided to the software applications where the task functions are to be performed. These payloads can be generated by execution contexts in the management framework, and, in particular, in management logic modules in the execution contexts which are configured to generate the order packets. In this disclosure, these management logic modules will be referred to as “action units.” In accordance with the disclosure, each of these action unit encapsulates transaction functions f and their corresponding rollback functions f⁻¹ into order packets provided by the action units to the software applications being managed, enabling consistent task processing management across different execution contexts respectively coupled to the software applications. It is noted that by abstracting task-processing management into units, such as the action units described herein, scaling applications across processes and machines becomes more straightforward compared to existing methods that may require significant reconfiguration. The concept of pairing each task function with its rollback function within the same action unit provides for consistent and immediate error handling.

As will be discussed in more detail herein, the order packets, including the payloads, can be respectively generated by each of a plurality of action units which are provided in the two or more different execution contexts in a unified software task-processing framework on a cloud server connected to two or more software applications. This allows the software task functions to be carried out by two different execution contexts to control task processing in the software applications that the framework is managing (for example, updating two or more applications on the same computer or in two or more applications in two or more different computers). In addition, upon detection of failure of the execution of a software task processing function on at least one of the applications, the software task processing can be automatically rolled back using both of the diverse execution contexts via the rollback functions which have been encapsulated into the payloads generated by each of the action blocks at the outset. This will correspondingly rollback the software task processing in both of the software applications.

Before discussing the drawing figures in detail, it is noted that the present disclosure is particularly useful in cases where it is desired to update applications on two or more computers or servers which are either dependent upon each other for operations, or where consistency of updating is important. For example, this can be a case where a plurality of computers are located in an office, and it is company policy that all of the applications of the multiple computers have the same security updates. In this situation, if, during the update of all of the applications on the office computers, the update of one or more of the applications fails for some reason, the present system and method will roll back the update of all of the applications so that the problem in the failed application(s) can be resolved. After the reason for the update failure is resolved, the update of all of the applications can be performed again.

As noted above, solely for purposes of example, the following discussion will be made in terms of managing task processing, such as updating software, on two different user devices connected to one another via the cloud, as shown in FIG. 1 (although, obviously, many more user devices could be updated and other tasks could be managed, if desired). However, it is to be understood that the present disclosure can be implemented in any situation involving task processing in computer software. For example, the techniques of the present disclosure can be used to manage tasks necessary for carrying out a manufacturing operation that involves either multiple applications on a single computer coupled to one or more manufacturing devices or the same or multiple applications on multiple computers coupled to the manufacturing devices. Another example could be for managing tasks carried out by multiple applications on one or more computers for controlling a vehicle. Still another example could be for managing tasks involved in making reservations for planning a trip (e.g., making airline reservations, hotel reservations, meeting reservations, etc.) that involves the coordination of tasks on multiple software applications. Yet another example could be to update account balances of a user (in-process transaction), notify other services running in separate processes (inter-process transaction), and coordinate with external banking systems over a network (distributed transaction).

Referring to the example shown in FIG. 1A for updating computer software on two or more applications, a computing environment 100 is shown having a user 1 computer/server 105A and a user 2 computer/server 105B coupled to a cloud server 110 via a network 115. The user 1 computer/server 105A includes a first application 120 and the user 2 computer/server includes a second application 125. In some implementations, the first application 120 and the second application 125 can be the same application on two different computers. However, in other implementations, these applications 120 and 125 can be different applications which are related to one another, and that can operate together on various tasks.

Still referring to FIG. 1A, the cloud server 110 can include a task-processing management framework 130 configured to manage the applications 120 and 125 by providing order packets to these respective applications via the network 115. Alternatively, as shown FIG. 1B, the task processing management framework 130 could be provided in a single device, such as the user one computer/server 105A, to manage the tasks processed by the first application 120 and the second application 125, which is different than the first application, on the same device.

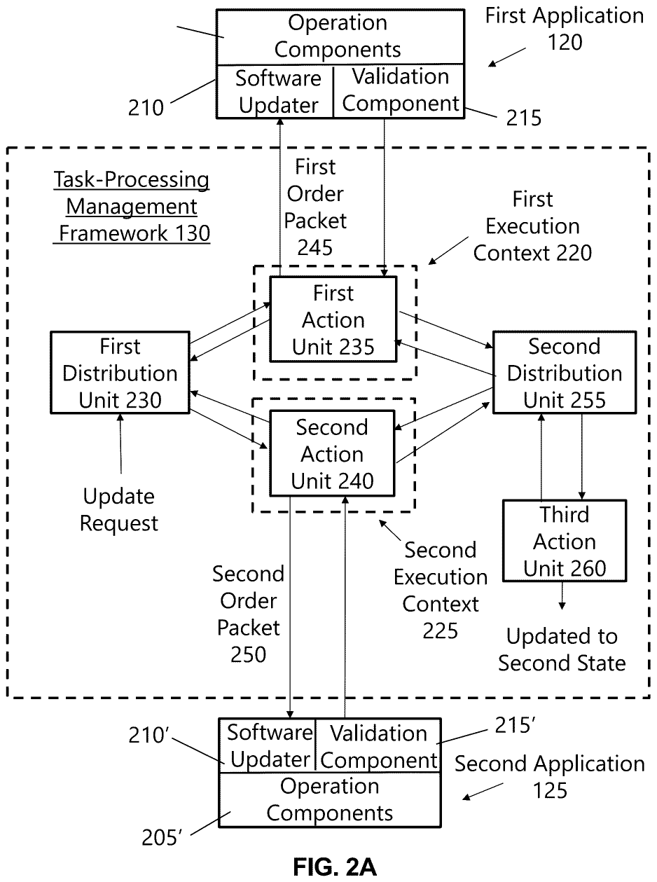

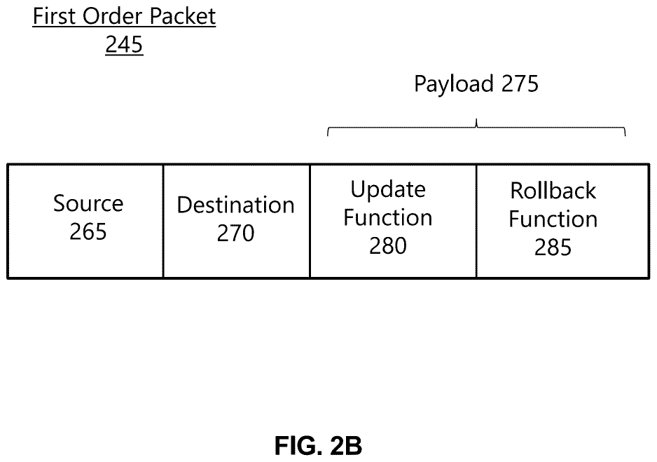

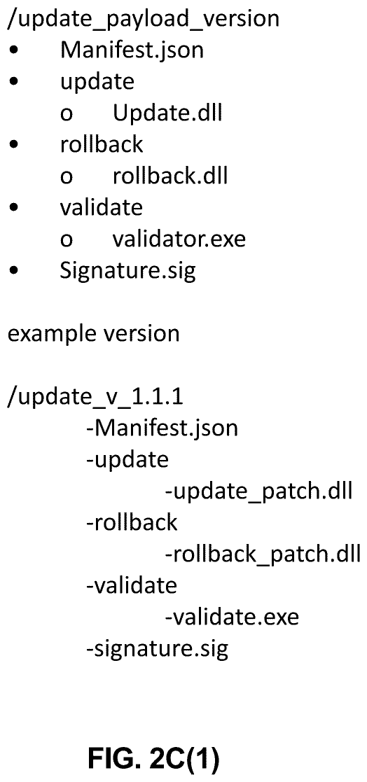

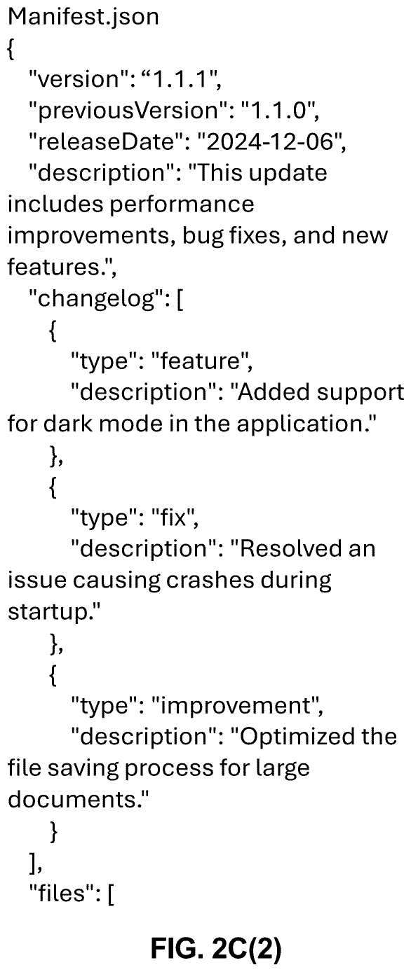

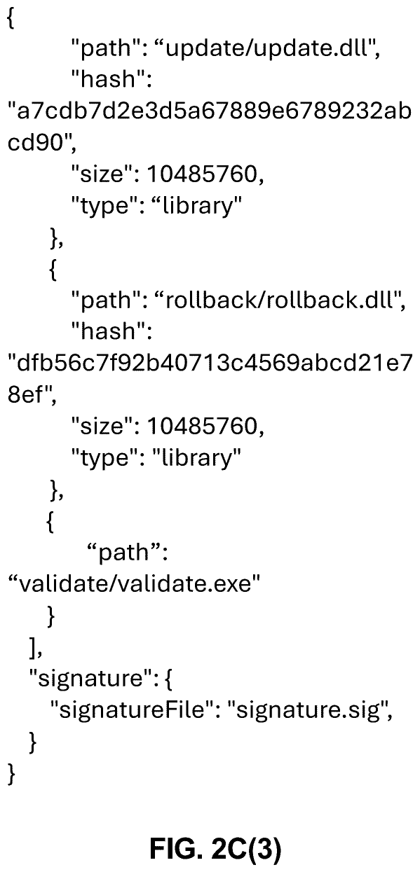

Referring to FIG. 2A, it can be seen that the first application 120 in the user 1 computer/server 105A can be made up of operation components 205 configured to actually carry out the desired tasks, a software task processor, in this example a software updater 210, and a validation component 215 indicate whether or not the software update has been successfully carried out in the the first application 120. Similarly, the second application 125 in the user 2 computer/server 105B also includes operation components 205′ to carry out the tasks, a software updater 210′ to update the software and a validation component 215′ to indicate whether or not the software update has been successfully carried out in the second application 125.

Still referring to FIG. 2A, the task processing management framework 130 includes a first execution context 220 coupled to the software updater 210 of the first application 120, and a second execution context 225 coupled to the software updater 210′ of the second application 125. The task processing management framework 130 also includes a first distribution unit 230 which receives an update request for updating the software applications 120 and 125 from a first state to a second state. In the case of distributing the software update request, the first distribution unit 230 operates as a fan-out unit to provide the update request to a first action unit 235 in the first execution context 220 and to a second action unit 240 in the second execution context 225. The first and second action units 235 and 240 are management logic modules, which perform the necessary logic operations, in response to the received update request, to form a first order packet 245 and a second order packet 250, respectively, to provide to the software updaters 210 and 210′ in the first and second applications 120 and 125, respectively. Alternatively, instead of having two separate action units, such as 235 and 240, serving as separate management logic modules, a single management logic module could be utilized to generate the separate packets 245 and 250. In this case, the single management logic module would include separate sub-modules, with a first sub-module generating the first order packet 245 and a second sub-module generating the second order packet 250.

The first and second order packets 245 and 250 provide the necessary information, in the form of a payload, for the software updaters 210 and 210′ to proceed with attempting to carry out the software update of the respective applications 120 and 125. After the first and second order packets 245 and 250 are generated by the first and second action units 235 and 240, they are dispatched for processing, respectively, to a first software task processor (in this example, the software updater 210) in the first software application 120 and to a second software task processor (in this example, the software updater 210) in the second software application 125.

With regard to the software updaters 210 and 210′, it is noted that all software applications include logic modules for providing the necessary tasks to achieve updating of the applications that they are a part of. Similarly, all software applications include other forms of task processors configured to carry out tasks which are assigned to the respective software applications. These software task processors are logic modules which include the necessary logic to respond to commands for performing specific tasks, utilizing the software application in question. For example, a unified child transaction software updater which runs locally in the client machine contains a list of applications installed in the client machine and manages the installation as described herein in FIG. 2C(1)-(3). The unified child transaction software updater also knows which applications are installed and pulls down the payload information based on the current application installed. It also manages the pointers to previous and next applications and walks forward through the pointers to install updates and backwards to rollback updates, as needed.

As will be discussed in further detail below, the first action unit 235 of FIG. 2A provides both the update function and the rollback function to the software updater 210 of the first application 120 via the first order packet 245. This internal software updater 210 then attempts to provide the software update to the first application 120 based upon the information provided in the first order packet 245. The validation component 215 of the first application 120 will provide an output to the first action unit 235 as to whether the update of the first application 120 was successful or not. If the validation component 215 of the first application 120 indicates that the update was not successful, the first action unit 235 will provide an output indicating this failure of the software updater 210 to successfully update the first application 120 to a second distribution unit 255. The second distribution unit 255, in turn, will provide this indication of update success or failure to a third action unit 260. As will be discussed below, this third action unit 260 will begin a rollback operation of the update upon receipt of a signal indicating update failure from the second distribution unit 255.

Similarly, the second action unit 240 performs update communications with the validation component 215′ of the second application 125 and, in the event of a failure of the software updater 210′ to successfully update the second application 125, the second action unit 240 will also provide a signal to the second distribution unit 255 indicating the update failure. The second distribution unit 255 will provide this indication of update failure in the second application 125 to the third action unit 260. As such, the second distribution unit 255 operates as a fan-in unit to receive separate inputs from the first action unit 235 and the second action unit 240 and provide these to the third action unit 260.

As was the case with regard to failure to successfully update the first application 120, this third action unit 260 will begin a rollback operation of the update upon receipt of a signal indicating update failure to successfully update the second application 125. In other words, upon determining that the update has failed in either of the software applications 120 or 125, the third action unit 260 will begin rollback of the update functions in both of the applications 120 and 125.

On the other hand, the third action unit 260 will provide an output indicating that the update has been successfully accomplished in both of the first and second software applications 120 and 125 and that the update has, therefore, been converted from a first initial state to a second state. In other words, when the validation components 215 and 215′ of both the first and second applications 120 and 125 indicate a successful update, the third action unit 260 will provide an indication of this successful performance of the update function that was processed in both applications. Regarding this, the software update can take place in stages, with multiple update functions needing to be performed to complete an overall update. In this case, the output from the third action unit 260 of the framework 130 can serve as an indication that one stage of the update has been successfully completed and that it is now time to advance to the next stage of the overall update by requesting performance of the next function in the overall update.

Referring next to FIG. 2B, a first order packet 245 sent from the first action unit 235 to the software updater 210 of the first application 120 is shown. It is noted that the second order packet 250 shown in FIG. 2A would be constructed in a similar manner. The first order packet 245 includes a source address 265, indicating the first action unit 235 as the source of the packet, a destination address 270, indicating the destination as the software updater 210 of the first application 120, and a payload 275. The payload 275 can include, among other items, an update function 280 (which can be one of several update functions that need to be carried out to complete an overall update) and a corresponding rollback function 285 (which is the opposite of the update function and which will only be activated if it is determined that the update function was not successfully processed by the application 120). Actual code used to implement the payload 275 of the first order packet 245 is shown in FIG. 2C(1)-(3).

As shown in FIG. 2C(1)-(3), the first and second order packets 245 and 250 each include a manifest instruction for proper processing of the first and second order packets and a validation instruction for validating a proper execution of the task function. More specifically, FIG. 2C(1) shows an example version the payload for each of the first and second order packets 245 and 250 including a manifest.json, and update.dll, a rollback.dll and validator.exe and a signature.sig. FIG. 2C(2) shows details for the manifest.json for the order packets. FIG. 2C(3) shows details of the coding for the update.dll, the rollback.dll, the validate.exe and the signature.sig.

In addition to communicating with the first and second applications in the manner described above, the first and second action units 235 and 240 can be constructed as conditional logic modules which only send the first and second packets, respectively, based upon determined conditions being satisfied. This can simplify operations and enable dynamic control flow in transaction execution. In addition, these conditional action units introduce the ability to execute transactions based on runtime conditions, providing adaptability that is lacking in traditional task processing management systems.

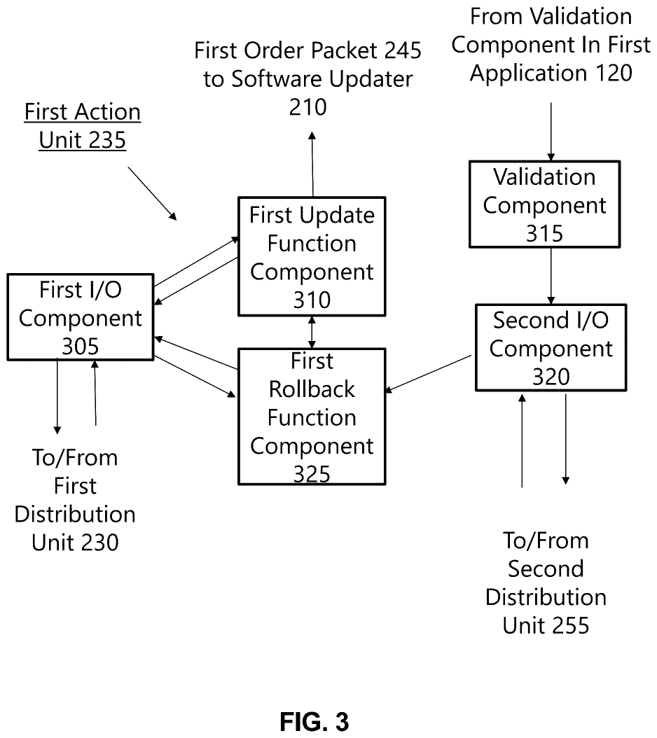

Referring next to FIG. 3, components of a first action unit 235 in the first execution context 220 are shown. As discussed above, the first action unit 235 coordinates with the software updater 210 of the first application 120 and with the validation component 215 of the first application 120 to provide a first order packet 245 to the software updater 210 and to receive an output from the validation component 215 of the first application 120 to determine if the software update has been successfully carried out in the first application 120. As shown in FIG. 3, the first action unit 235 includes a first I/O component 305 to receive a request for an update function from the first distribution unit 230 and to provide this update request to a first update function component 310. The update request is used by the first update function component 310 to formulate the first order packet 245 shown in FIG. 2B. Specifically, the first update function component 310 is configured to prepare the first order packet 245 shown in FIG. 2B and FIG. 2C(1)-(3).

As also shown in FIG. 3, the first action unit 135 also includes a validation component 315 to receive an input from the validation component 215 of the first application 120. This validation component 315 will provide an output to a second I/O component 320 to indicate whether the software update in the first application 120 has been successful or not. The second I/O component 320 will provide an output to the second distribution unit 255, which output will be provided to the second distribution unit 255, and, from there, to the third action unit 260. If the validation component 315 indicates that the update in the first application 120 was not successful, a rollback command will be provided from the third action unit 260 to the second I/O component 320 to activate the first rollback function component 325 to begin the rollback function operation, as will be described below.

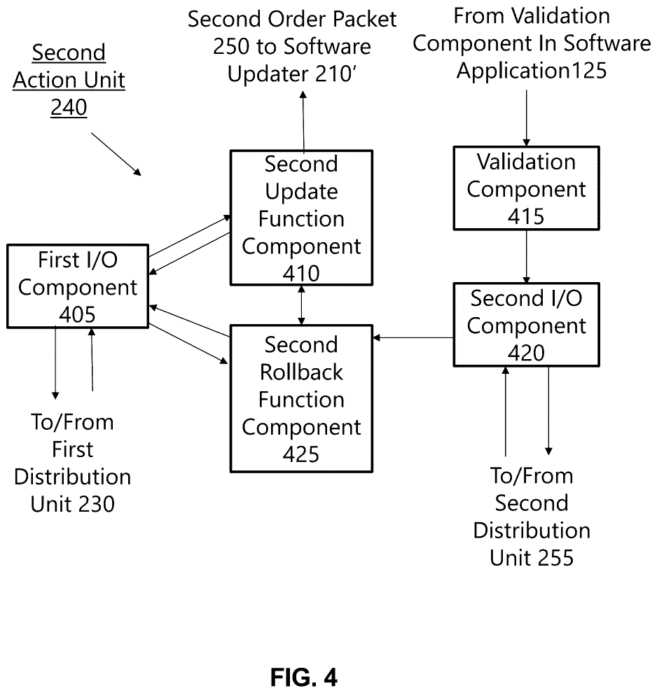

FIG. 4 shows components of the second action unit 240 which correspond to the components discussed above for the first action unit 235. Specifically, the first I/O component 405, the second update function component 410, the validation component 415, the second I/O component 420 and the second rollback function component 425 all perform the same respective operations as the first I/O component 305, the second update function component 310, the validation component 315, the second I/O component 320 and the second rollback function component 325 discussed above with regard to FIG. 3, except that these components of FIG. 4 perform these operations with regard to the success or failure of the update of the second application 125.

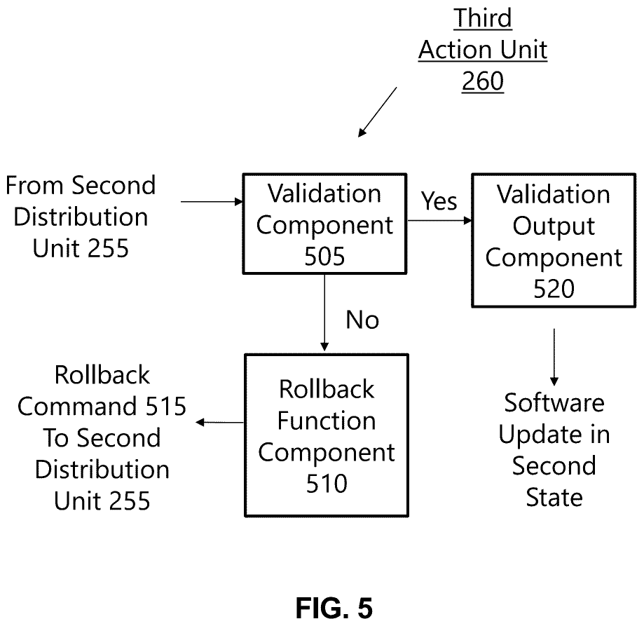

The automatic rollback operation is shown, for example, in FIG. 5. Specifically, the first outputs of processing of the software update function by the first and second action units 235 and 240 (which first outputs indicate whether the software updating of the software updaters of the first and second user computers has been successful or not) are applied to a third action unit 260, via a second distribution unit 255 in the software update framework 130 in the cloud server 110. Whether or not the software update function has been successful can be determined by validation components 320 and 420 respectively provided in each of the first and second action units 235 and 240. As shown in FIG. 5, the third action unit 260 also includes a validation component 520 to determine if the validation components 315 and 415 of the first action unit 235 and the second action unit 240 have received indications from the validation components 315 and 315′ that the first and second software applications 120 and 125 have both successfully carried out the software update function or failed to do so.

If it is determined by the validation component 505 of the third action unit 260 from the respective first outputs of the first and second action units 235 and 240 that the first and second applications 120 and 125 have both successfully performed the software update function, a validation output is provided by the validation output component 520 from the third action unit 260 indicating that the software update has been successfully converted to the second stable state.

On the other hand, as shown in FIG. 5, if it is determined in the validation component 505 of the third action unit from the respective first outputs of the first and second action units 235 and 240 that either of the first or second action units did not successfully perform the software update function, a rollback command 515 is automatically provided, via a rollback function component 510 in the third action unit 260 to the second distribution unit 255 to rollback function components 325 and 426 included in the first and second action units 235 and 240, respectively. This will automatically roll back the software update in both the first and second applications 120 and 125 via the first and second action units 235 and 240 to roll back the software update in both the first and second applications 120 and 125. It is noted that this description only pertains to describing a single function of a software update, but, in fact, many software updates include multiple functions that must be carried out in sequence to complete the software update.

A technical advantage of this approach is that it allows automatic rollback of the software update (or other task functions) in the different execution contexts in case of failure to successfully perform one of the software update functions in one of the applications without the data inconsistencies, increased complexity, and lack of automaticity, consistency, isolation, and durability found in existing systems. In particular, the disclosed approach embeds rollback logic within each action unit to provide in the payloads of the order packets to the different applications, ensuring immediate and consistent recovery in the event of failure to execute a requested task function.

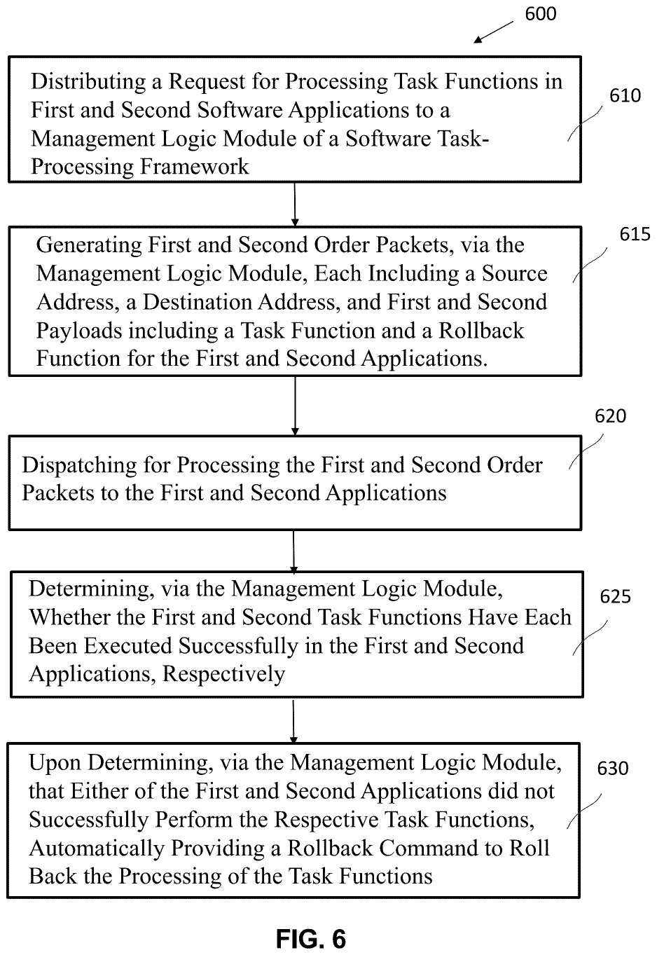

FIG. 6 is a flow chart of an example process 600 of an example process for managing processing of task functions in a first software application and a second software application coupled to the software task-processing framework system according to the techniques disclosed herein. The process 600 can be implemented by the task-processing management framework shown in FIGS. 1A and 1B.

The process 600 includes a first step 610 of distributing a request for processing task requests in first and second software applications 120 and 125 to a management logic module (such as the first and second action units 235 and 240) of the software task processing framework, such as the framework 130. In step 615, first and second order packets 245 and are generated using the management logic module. Each of these first and second order packets 245 and 250 includes a source address, destination, address, and first and second payloads. As discussed previously, the payloads 275 can each include a task function 280 and a rollback function 285 with regard to processing of the tasks in the first and second applications.

The process 600 also includes the step 620 for dispatching the first and second order packets 245 and 250 for processing in the first and second applications 120 and 125 after they have been generated by the management logic module(s), such as the action units 635 and 640. In step 625, these first and second order packets 245 and 250 are processed, and the management logic module(s), such as the action units 245 and 250, can determine whether the first and second task functions have been successfully executed in the first and second application 120 and 125, respectively, via validation components 215 and 215′ provided in each of the first and second applications 120 and 125.

The process 600 also includes the step 630 in which, upon determining, via the management logic module(s) (such as the action units 235 and 240), that either of the first or second applications 120 and 125 did not successfully complete the respective task functions provided in the first and second order packets 245 and 250, a rollback command 515 will automatically be provided (e.g., from the third action unit 260 shown in FIGS. 2 and 5) to roll back the processing of the task functions in the first and second applications 120 and 125.

The detailed examples of systems, devices, and techniques described in connection with FIGS. 1-6 are presented herein for illustration of the disclosure and its benefits. Such examples of use should not be construed to be limitations on the logical process embodiments of the disclosure, nor should variations of user interface methods from those described herein be considered outside the scope of the present disclosure. It is understood that references to displaying or presenting an item (such as, but not limited to, presenting an image on a display device, presenting audio via one or more loudspeakers, and/or vibrating a device) include issuing instructions, commands, and/or signals causing, or reasonably expected to cause, a device or system to display or present the item. In some embodiments, various features described in FIGS. 1-6 are implemented in respective modules, which may also be referred to as, and/or include, logic, components, units, and/or mechanisms. Modules may constitute either software modules (for example, code embodied on a machine-readable medium) or hardware modules.

In some examples, a hardware module may be implemented mechanically, electronically, or with any suitable combination thereof. For example, a hardware module may include dedicated circuitry or logic that is configured to perform certain operations. For example, a hardware module may include a special-purpose processor, such as a field-programmable gate array (FPGA) or an Application Specific Integrated Circuit (ASIC). A hardware module may also include programmable logic or circuitry that is temporarily configured by software to perform certain operations and may include a portion of machine-readable medium data and/or instructions for such configuration. For example, a hardware module may include software encompassed within a programmable processor configured to execute a set of software instructions. It will be appreciated that the decision to implement a hardware module mechanically, in dedicated and permanently configured circuitry, or in temporarily configured circuitry (for example, configured by software) may be driven by cost, time, support, and engineering considerations.

Accordingly, the phrase “hardware module” should be understood to encompass a tangible entity capable of performing certain operations and may be configured or arranged in a certain physical manner, be that an entity that is physically constructed, permanently configured (for example, hardwired), and/or temporarily configured (for example, programmed) to operate in a certain manner or to perform certain operations described herein. As used herein, “hardware-implemented module” refers to a hardware module. Considering examples in which hardware modules are temporarily configured (for example, programmed), each of the hardware modules need not be configured or instantiated at any one instance in time. For example, where a hardware module includes a programmable processor configured by software to become a special-purpose processor, the programmable processor may be configured as respectively different special-purpose processors (for example, including different hardware modules) at different times. Software may accordingly configure a processor or processors, for example, to constitute a particular hardware module at one instance of time and to constitute a different hardware module at a different instance of time. A hardware module implemented using one or more processors may be referred to as being “processor implemented” or “computer implemented.”

Hardware modules can provide information to, and receive information from, other hardware modules. Accordingly, the described hardware modules may be regarded as being communicatively coupled. Where multiple hardware modules exist contemporaneously, communications may be achieved through signal transmission (for example, over appropriate circuits and buses) between or among two or more of the hardware modules. In embodiments in which multiple hardware modules are configured or instantiated at different times, communications between such hardware modules may be achieved, for example, through the storage and retrieval of information in memory devices to which the multiple hardware modules have access. For example, one hardware module may perform an operation and store the output in a memory device, and another hardware module may then access the memory device to retrieve and process the stored output.

In some examples, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by, and/or among, multiple computers (as examples of machines including processors), with these operations being accessible via a network (for example, the Internet) and/or via one or more software interfaces (for example, an application program interface (API)). The performance of certain of the operations may be distributed among the processors, not only residing within a single machine, but deployed across several machines. Processors or processor-implemented modules may be in a single geographic location (for example, within a home or office environment, or a server farm), or may be distributed across multiple geographic locations.

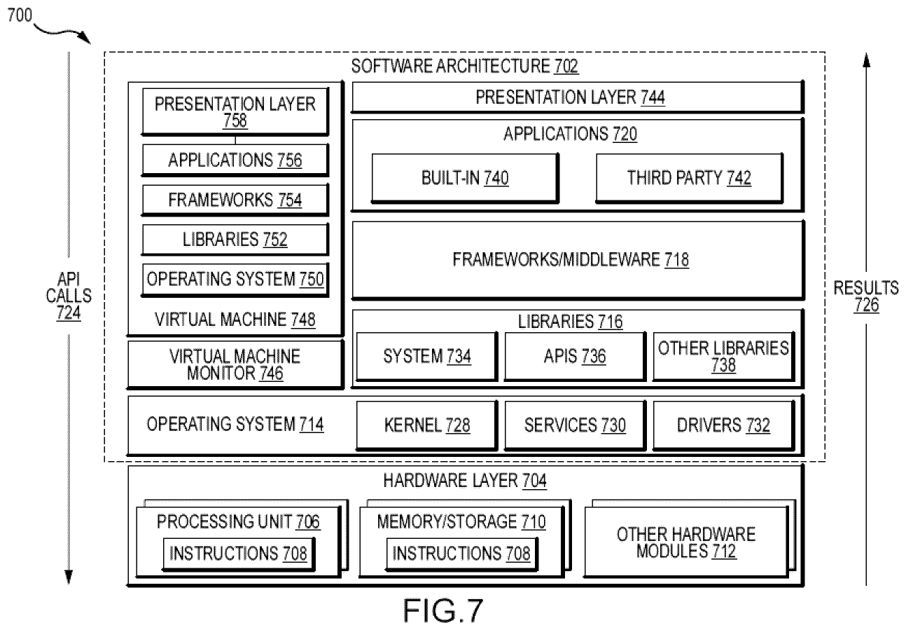

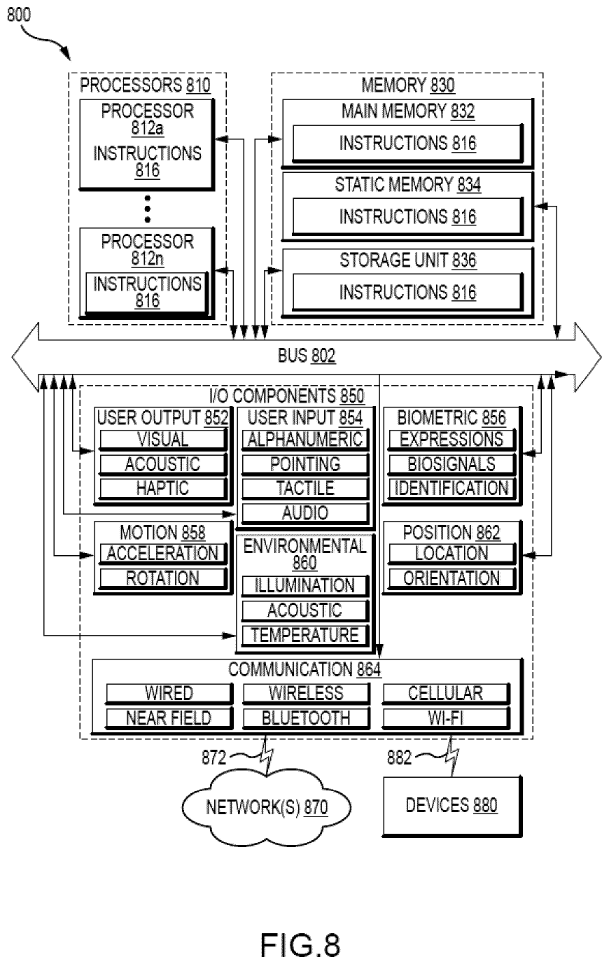

FIG. 7 is a block diagram 700 illustrating an example software architecture 702, various portions of which may be used in conjunction with various hardware architectures herein described, which may implement any of the above-described features. The unified task-processing management framework 130 described herein is software application, and can be implemented with the software architecture 702. FIG. 7 is a non-limiting example of a software architecture, and it will be appreciated that many other architectures may be implemented to facilitate the functionality described herein. The software architecture 702 may execute on hardware such as a machine 800 of FIG. 8 that includes, among other things, processors 810, memory 830, and input/output (I/O) components 850. A representative hardware layer 704 is illustrated and can represent, for example, components of the unified task-processing management framework 130 described herein. The representative hardware layer 704 includes a processing unit 706 and associated executable instructions 708. The executable instructions 708 represent executable instructions of the software architecture 702, including implementation of the methods, modules and so forth described herein. The hardware layer 704 also includes a memory/storage 710, which also includes the executable instructions 708 and accompanying data. The hardware layer 704 may also include other hardware modules 712. Instructions 708 held by processing unit 706 may be portions of instructions 708 held by the memory/storage 710.

The example software architecture 702 may be conceptualized as layers, each providing various functionality. For example, the software architecture 702 may include layers and components such as an operating system (OS) 714, libraries 716, frameworks 718, applications 720, and a presentation layer 744. Operationally, the applications 720 and/or other components within the layers may invoke API calls 724 to other layers and receive corresponding results 726. The layers illustrated are representative in nature and other software architectures may include additional or different layers. For example, some mobile or special purpose operating systems may not provide the frameworks/middleware 718.

The OS 714 may manage hardware resources and provide common services. The OS 714 may include, for example, a kernel 728, services 730, and drivers 732. The kernel 728 may act as an abstraction layer between the hardware layer 704 and other software layers. For example, the kernel 728 may be responsible for memory management, processor management (for example, scheduling), component management, networking, security settings, and so on. The services 730 may provide other common services for the other software layers. The drivers 732 may be responsible for controlling or interfacing with the underlying hardware layer 704. For instance, the drivers 732 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 716 may provide a common infrastructure that may be used by the applications 720 and/or other components and/or layers. The libraries 716 typically provide functionality for use by other software modules to perform tasks, rather than rather than interacting directly with the OS 714. The libraries 716 may include system libraries 734 (for example, C standard library) that may provide functions such as memory allocation, string manipulation, file operations. In addition, the libraries 716 may include API libraries 736 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 716 may also include a wide variety of other libraries 738 to provide many functions for applications 720 and other software modules.

The frameworks 718 (also sometimes referred to as middleware) provide a higher-level common infrastructure that may be used by the applications 720 and/or other software modules. For example, the frameworks 718 may provide various graphic user interface (GUI) functions, high-level resource management, or high-level location services. The frameworks 718 may provide a broad spectrum of other APIs for applications 720 and/or other software modules.

The applications 720 include built-in applications 740 and/or third-party applications 742. Examples of built-in applications 740 may include, but are not limited to, a contacts application, a browser application, a location application, a media application, a messaging application, and/or a game application. Third-party applications 742 may include any applications developed by an entity other than the vendor of the particular platform. The applications 720 may use functions available via OS 714, libraries 716, frameworks 718, and presentation layer 744 to create user interfaces to interact with users.

Some software architectures use virtual machines, as illustrated by a virtual machine 748. The virtual machine 748 provides an execution environment where applications/modules can execute as if they were executing on a hardware machine (such as the machine 800 of FIG. 8, for example). The virtual machine 748 may be hosted by a host OS (for example, OS 714) or hypervisor, and may have a virtual machine monitor 746 which manages operation of the virtual machine 748 and interoperation with the host operating system. A software architecture, which may be different from software architecture 702 outside of the virtual machine, executes within the virtual machine 748 such as an OS 750, libraries 752, frameworks 754, applications 756, and/or a presentation layer 758.

FIG. 8 is a block diagram illustrating components of an example machine 800 configured to read instructions from a machine-readable medium (for example, a machine-readable storage medium) and perform any of the features described herein. The example machine 800 is in a form of a computer system, within which instructions 816 (for example, in the form of software components) for causing the machine 800 to perform any of the features described herein may be executed. As such, the instructions 816 may be used to implement modules or components described herein. The instructions 816 cause unprogrammed and/or unconfigured machine 800 to operate as a particular machine configured to carry out the described features. The machine 800 may be configured to operate as a standalone device or may be coupled (for example, networked) to other machines. In a networked deployment, the machine 800 may operate in the capacity of a server machine or a client machine in a server-client network environment, or as a node in a peer-to-peer or distributed network environment. Machine 800 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 800 is illustrated, the term “machine” includes a collection of machines that individually or jointly execute the instructions 816.

The machine 800 may include processors 810, memory 830, and I/O components 850, which may be communicatively coupled via, for example, a bus 802. The bus 802 may include multiple buses coupling various elements of machine 800 via various bus technologies and protocols. In an example, the processors 810 (including, for example, a central processing unit (CPU), a graphics processing unit (GPU), a digital signal processor (DSP), a field programmable gate array (FPGA), an ASIC, or a suitable combination thereof) may include one or more processors 812a to 812n that may execute the instructions 816 and process data. In some examples, one or more processors 810 may execute instructions provided or identified by one or more other processors 810. The term “processor” includes a multi-core processor including cores that may execute instructions contemporaneously. Although FIG. 8 shows multiple processors, the machine 800 may include a single processor with a single core, a single processor with multiple cores (for example, a multi-core processor), multiple processors each with a single core, multiple processors each with multiple cores, or any combination thereof. In some examples, the machine 800 may include multiple processors distributed among multiple machines.

The memory/storage 830 may include a main memory 832, a static memory 834, or other memory, and a storage unit 836, both accessible to the processors 810 such as via the bus 802. The storage unit 836 and memory 832, 834 store instructions 816 embodying any one or more of the functions described herein. The memory/storage 830 may also store temporary, intermediate, and/or long-term data for processors 810. The instructions 816 may also reside, completely or partially, within the memory 832, 834, within the storage unit 836, within at least one of the processors 810 (for example, within a command buffer or cache memory), within memory at least one of I/O components 850, or any suitable combination thereof, during execution thereof. Accordingly, the memory 832, 834, the storage unit 836, memory in processors 810, and memory in I/O components 850 are examples of machine-readable media.

As used herein, “machine-readable medium” refers to a device able to temporarily or permanently store instructions and data that cause machine 800 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 816) for execution by a machine 800 such that the instructions, when executed by one or more processors 810 of the machine 800, cause the machine 800 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 850 may include a wide variety of hardware components adapted to receive input, provide output, produce output, transmit information, exchange information, capture measurements, and so on. The specific I/O components 850 included in a particular machine will depend on the type and/or function of the machine. For example, mobile devices such as mobile phones may include a touch input device, whereas a headless server or IoT device may not include such a touch input device. The particular examples of I/O components illustrated in FIG. 8 are in no way limiting, and other types of components may be included in machine 800. The grouping of I/O components 850 are merely for simplifying this discussion, and the grouping is in no way limiting. In various examples, the I/O components 850 may include user output components 852 and user input components 854. User output components 852 may include, for example, display components for displaying information (for example, a liquid crystal display (LCD) or a projector), acoustic components (for example, speakers), haptic components (for example, a vibratory motor or force-feedback device), and/or other signal generators. User input components 854 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 850 may include biometric components 856, motion components 858, environmental components 860, and/or position components 862, among a wide array of other physical sensor components. The biometric components 856 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 858 may include, for example, acceleration sensors (for example, an accelerometer) and rotation sensors (for example, a gyroscope). The environmental components 860 may include, for example, illumination sensors, temperature sensors, humidity sensors, pressure sensors (for example, a barometer), acoustic sensors (for example, a microphone used to detect ambient noise), proximity sensors, for example, infrared sensing of nearby objects), and/or other components that may provide indications, measurements, or signals corresponding to a surrounding physical environment. The position components 862 may include, for example, location sensors (for example, a Global Position System (GPS) receiver), altitude sensors (for example, an air pressure sensor from which altitude may be derived), and/or orientation sensors (for example, magnetometers).

The I/O components 850 may include communication components 864, implementing a wide variety of technologies operable to couple the machine 800 to network(s) 870 and/or device(s) 880 via respective communicative couplings 872 and 882. The communication components 864 may include one or more network interface components or other suitable devices to interface with the network(s) 870. The communication components 864 may include, for example, components adapted to provide wired communication, wireless communication, cellular communication, Near Field Communication (NFC), Bluetooth communication, Wi-Fi, and/or communication via other modalities. The device(s) 880 may include other machines or various peripheral devices (for example, coupled via USB).

In some examples, the communication components 864 may detect identifiers or include components adapted to detect identifiers. For example, the communication components 864 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 864, such as, but not limited to, geo-location via Internet Protocol (IP) address, location via Wi-Fi, cellular, NFC, Bluetooth, or other wireless station identification and/or signal triangulation, as well as RF analog signal processing components, including analog to digital converters.

In the preceding detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article, or apparatus are capable of performing all of the recited functions.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A software task-processing framework system for managing processing of task functions in a first software application and a second software application coupled to the software task-processing framework system, the system comprising:
a processor; and
a memory storing executable instructions that, when executed, cause the processor alone or in combination with other processors to perform operations of:
distributing a request for processing first and second task functions in the first and second software applications, respectively, to the software task-processing framework system;
generating a first order packet, via the software task-processing framework system, including a source address to identify the software task-processing framework system as a source, a destination address to identify the first software application as a first destination, and a first payload, the first payload including the first task function and a first rollback function, wherein the first rollback function is programmed to automatically rollback processing of the first task function upon detecting a failure in processing the first task function by the first software application;
generating a second order packet, via the software task-processing framework system, including a source address to identify the software task-processing framework system as the source, a destination address to identify the second software application as a second destination, and a second payload, the second payload including the second task function and a second rollback function, wherein the second rollback function is programmed to automatically rollback processing of the second task function upon detecting a failure in processing the second task function by the second software application;
dispatching for processing the first order packet to a first software task processor in the first software application and the second order packet to a second software task processor in the second software application;
determining, via the software task-processing framework system, whether the first and second task functions have each been executed successfully in the first and second software applications, respectively, by the first and second software task processors; and
upon determining, via the software task-processing framework system, that either of the first and second task processors did not successfully perform the respective first or second task functions, automatically providing a rollback command to both the first and second task processors, via the software task-processing framework system, to direct the first and second task processors to execute the first and second rollback functions, respectively, to roll back the processing of the first and second task functions.

2. The system of claim 1, wherein the first and second task functions are a same task function.

3. The system of claim 1, wherein the first and second task functions are software updates of the first and second software applications, respectively.

4. The system of claim 1, wherein the software task-processing framework system will only send the first and second packets, respectively, based upon predetermined conditions being satisfied.

5. The system of claim 1, wherein the software task-processing framework system is located in a cloud server, the first software application is located in a first user device coupled to the cloud server, and the second software application is located in a second user device coupled to the cloud server.

6. The system of claim 1, wherein the software task-processing framework system, the first software application, and the second software application are located in a first user device.

7. The system of claim 1, wherein the first and second order packets each include a manifest instruction for processing of the first and second order packets and a validation instruction for validating execution of the task function.

8. The system of claim 1, wherein the first and second software applications are a same type of software application.

9. The system of claim 1, wherein the first and second software applications are different types of software applications.

10. A method for managing processing of task functions in a first software application and a second software application, via coupled a software task-processing framework system coupled to the first and second software applications, the method comprising:
distributing a request for processing first and second task functions in the first and second software applications, respectively, to the software task-processing framework system;
generating a first order packet, via the software task-processing framework system, including a source address to identify the software task-processing framework system as a source, a destination address to identify the first software application as a first destination, and a first payload, the first payload including the first task function and a first rollback function, wherein the first rollback function is programmed to automatically rollback processing of the first task function upon detecting a failure in processing the first task function by the first software application;
generating a second order packet, via the software task-processing framework system, including a source address to identify the software task-processing framework system as the source, a destination address to identify the second software application as a second destination, and a second payload, the second payload including the second task function and a second rollback function, wherein the second rollback function is programmed to automatically rollback processing of the second task function upon detecting a failure in processing the second task function by the second software application;
dispatching for processing the first order packet to a first software task processor in the first software application and the second order packet to a second software task processor in the second software application;
determining, via the software task-processing framework system, whether the first and second task functions have each been executed successfully in the first and second software applications, respectively, by the first and second software task processors; and
upon determining, via the software task-processing framework system, that either of the first and second task processors did not successfully perform the respective first or second task functions, automatically providing a rollback command to both the first and second task processors, via the software task-processing framework system, to direct the first and second task processors to execute the first and second rollback functions, respectively, to roll back the processing of the first and second task functions.

11. The system of claim 10, wherein the first and second task functions are a same task function.

12. The system of claim 10, wherein the first and second task functions are software updates of the first and second software applications, respectively.

13. The system of claim 10, wherein the software task-processing framework system will only send the first and second packets, respectively, based upon predetermined conditions being satisfied.

14. The system of claim 10, wherein the software task-processing framework system is located in a cloud server, the first software application is located in a first user device coupled to the cloud server, and the second software application is located in a second user device coupled to the cloud server.

15. The system of claim 10, wherein the software task-processing framework system, the first software application, and the second software application are located in a first user device.

16. The system of claim 10, wherein the first and second order packets each include a manifest instruction for processing of the first and second order packets and a validation instruction for validating execution of the task function.

17. The system of claim 10, wherein the first and second software applications are a same type of software application.

18. The system of claim 1, wherein the first and second software applications are different types of software applications.

19. A computer-readable storage medium for managing processing of task functions in a first software application and a second software application, via coupled a software task-processing framework system coupled to the first and second software applications, having instructions stored thereon that, when executed by a processing system, perform a method comprising:
distributing a request for processing first and second task functions in the first and second software applications, respectively, to the software task-processing framework system;
generating a first order packet, via the software task-processing framework system, including a source address to identify the software task-processing framework system as a source, a destination address to identify the first software application as a first destination, and a first payload, the first payload including the first task function and a first rollback function, wherein the first rollback function is programmed to automatically rollback processing of the first task function upon detecting a failure in processing the first task function by the first software application;
generating a second order packet, via the software task-processing framework system, including a source address to identify the software task-processing framework system as the source, a destination address to identify the second software application as a second destination, and a second payload, the second payload including the second task function and a second rollback function, wherein the second rollback function is programmed to automatically rollback processing of the second task function upon detecting a failure in processing the second task function by the second software application;
dispatching for processing the first order packet to a first software task processor in the first software application and the second order packet to a second software task processor in the second software application;
determining, via the software task-processing framework system, whether the first and second task functions have each been executed successfully in the first and second software applications, respectively, by the first and second software task processors; and upon determining, via the software task-processing framework system, that either of the first and second task processors did not successfully perform the respective first or second task functions, automatically providing a rollback command to both the first and second task processors, via the software task-processing framework system, to direct the first and second task processors to execute the first and second rollback functions, respectively, to roll back the processing of the first and second task functions.

20. The system of claim 19, wherein the first and second task functions are software updates of the first and second software applications, respectively.
